(19) United States
(12) Patent Application Publication
(10) Pub. No.: US 2007/0095808 A1
(43) Pub. Date: May 3, 2007

(54) Electrically heated clothing article

(76) Inventor: Edward Lacy III, New Carrollton, MD (US)

Correspondence Address: LIEBERMAN & BRANDSDORFER, LLC, 802 STILL CREEK LANE, GAITHERSBURG, MD, 20878, US

(21) Appl. No.: 11/265,353

(22) Filed: Nov. 2, 2005

(51) Int. Cl. H05B 3/00

(52) U.S. Cl. 219/211

(57) ABSTRACT

This invention comprises a clothing article and method of heating the article wherein a heat conducting element passes along the perimeter of the clothing article. Connected to the heat conducting element is a power source and heat controlling elements. The clothing article is adapted such that the power source is contained within a enclosure on the clothing article and the heat controlling elements are sewn within the fabric of the clothing article. Also, connected to heat conducting element are electrodes located at both ends of the heat conducting means and within housings at opposing ends of the clothing article. By bringing the two electrodes into contact, the electrodes function to complete the circuit of the heat conducting element. Moreover, by bringing the two electrodes into contact, the electrodes function to secure the clothing apparatus to the user.

### BACKGROUND OF THE INVENTION

1. Technical Field

This invention relates to a clothing article adapted to be heated. More specifically, the clothing article is heated through a heat conducting element that extends along the perimeter with electrodes at both ends of the heat conducting element.

2. Description of the Prior Art

Typically, an electrically heated glove is comprised of a heat conducting element and a power source. In a complete circuit, the heat conducting element and the power source function to activate the heat conducting means and, in turn, heat the user's hand secured within the glove.

There are numerous products that invite the use of an electrically heated clothing article. For example, U.S. Pat. No. 3,632,966 to Arron discloses a mitten with a heating element. The mitten contains an electrical ribbon along the fingertips that is connected to a battery power source within a enclosure on the mitten's wrist. Once the battery source is connected into the electrical ribbon, the electrical ribbon begins to heat the user's hand. Another example is found in U.S. Pat. No. 6,239,410 to Tackore, which discloses a glove with a heating coil, a power source and thermometer. In the preferred embodiment, the heating coil is disposed within the entire interior of the glove. The power source is, preferably, a battery that is in communication with the heating coil. The thermometer measures the temperature outside of the glove and is in communication with the power source to regulate power to the heating coil.

It is further known in the art to use two or more electrical conductors which, when placed into contact, function to complete the circuit between the power source and the heating element. However, there are drawbacks associated with use of electronic circuitry without any function to secure the glove to the user. For example, U.S. Pat. No. 5,541,388 to Gadd and U.S. Pat. No. 4,764,665 to Orban et al., both disclose heated gloves where the conductors between the power source and the heating element meet outside of the glove element such that, when the heated glove is turned on, the conductors extend from the glove and may be accidentally disconnected. Furthermore, European Patent Application No. EP 1400182 to Yamazaki et al. discloses a heated glove where the conductors contact both ends of the power source directly, but they do not function to secure the heated glove to the user's hand.

Although it is known in the art to apply a heating element to a glove, there is no teaching in the art to apply the use of a heating element, power source, thermometer, and electrical conductors in a cost efficient manner where contact between the conductors completes the circuit between the heating element, the power source and the thermometer, and it also physically secures the glove to the user. Accordingly, there is a need for an electrically heated glove that functions in such a manner.

### SUMMARY OF THE INVENTION

This invention comprises a clothing apparatus and a method of heating the apparatus and securing the apparatus to the user.

In one aspect of the invention, an apparatus is provided that is a glove, or the like, wherein the glove is adapted to secure to a user's hand and a heat conducting element is contained within the glove. The heat conducting element extends along the entire perimeter of the glove's fingers and palm with a first end at a posterior side of the glove and a second end at an anterior side of the glove. The heat conducting element is adapted to deliver heat to the user's hand when the hand is secured within the glove. In a preferred embodiment, the heat conducting element is a metal wire, or the like.

In another aspect of the invention, an apparatus is provided that is a glove, or the like, with a heat conducting element and a heat controlling element. The heat controlling element is adapted to communicate with the heat conducting element to adjust the heat flow into the glove. In one embodiment, the heat controlling element is a resistor that is contained on the heat conducting element and embedded within the fabric of the glove. In a second embodiment, the heat controlling element also contains a thermostat that is contained on the heat conducting element and embedded within the fabric of the glove.

In a further aspect of the invention, an apparatus is provided that is a glove, or the like, having a heat conducting element and a power source. The power source is adapted to communicate with the heat controlling element and provide power to activate the heat conducting element and heat the glove. In a preferred embodiment the power source is a battery, or the like, and is contained embedded within the fabric of the glove.

In yet another aspect of the invention, an apparatus and method is provided that is a glove, or the like, having a heat conducting element, a power source, and two or more electrodes. The electrodes, when in contact with one another, complete the circuit between the heat conducting element, the heat controlling element and the power source. The first electrode is connected to first end of the heat conducting element within a first housing embedded in a posterior side of the glove and the second electrode is connected to the heat conducting element within a second housing embedded in an anterior of the glove. In one embodiment, mechanical contact between the first housing and the second housing functions to connect the electrodes, activate the heat conducting element and secure the glove to the user. Contact between the first and second housings may be in the form of magnetic material, hook and loop fasteners and combinations thereof.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a top plan view of a posterior side of a clothing article.

FIG. 2 is a bottom plan view of an anterior side of a clothing article.

FIG. 3 is a side view of a mechanical securing mechanism.

FIG. 4 is a side view of a magnetic securing mechanism.

FIG. 5 is a side view of a hook and loop fastener securing mechanism.

FIG. 6a is a side view of the thermostat in a first position.

FIG. 6b is a side view of the thermostat in a second position.

FIG. 7 is a top plan view of a battery enclosure.

### DESCRIPTION OF THE PREFERRED EMBODIMENTS

### Overview

The heated clothing apparatus relates to heat conducting and controlling elements embedded within the fabric of a clothing article, such as a glove or a mitten, that are intended to warm a user's extremity when secured within the apparatus. The heated apparatus has several aspects which control the flow of heat into the glove. First, the heated apparatus is comprised of a heat conducting element. The heat conducting element begins at an opening to the heated apparatus, extends along the entire perimeter of the clothing apparatus and terminates at the opposing end of the opening to the clothing article. Second, the heated apparatus is comprised of power source. The power source is in communication with the heat conducting element and provides heat to the heat conducting element. Third, the heating apparatus is comprised of a heat controlling element. The heat controlling element is also in communication with the heat conducting element and functions to control the flow of heat from the power source to the heat conducting element. Finally, the heating apparatus is comprised of two electrodes. The first electrode is in communication with a first end of the heat conducting element and the second electrode is in communication with a second end of the heat conducing element. When the first and second electrodes are brought into contact, they function to secure the article to the user's extremity and to complete the circuit between the heat conducting element, the power source, and the heat controlling element.

### Technical Details

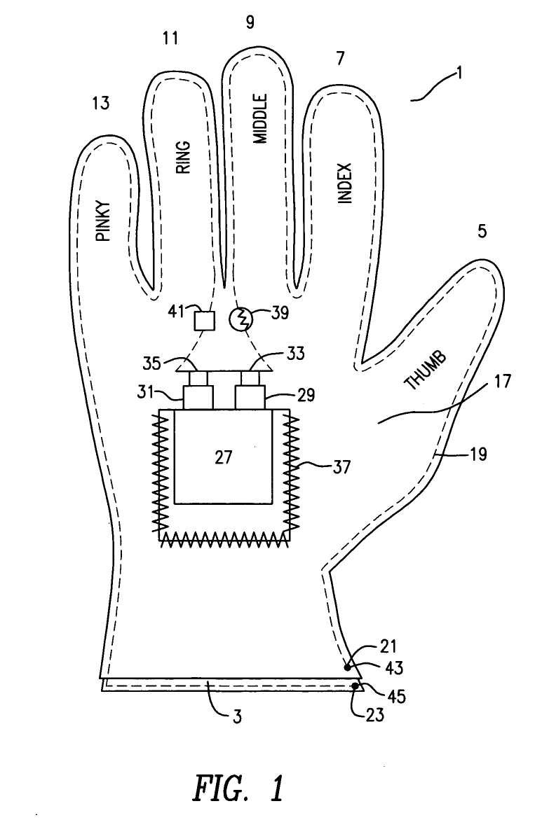

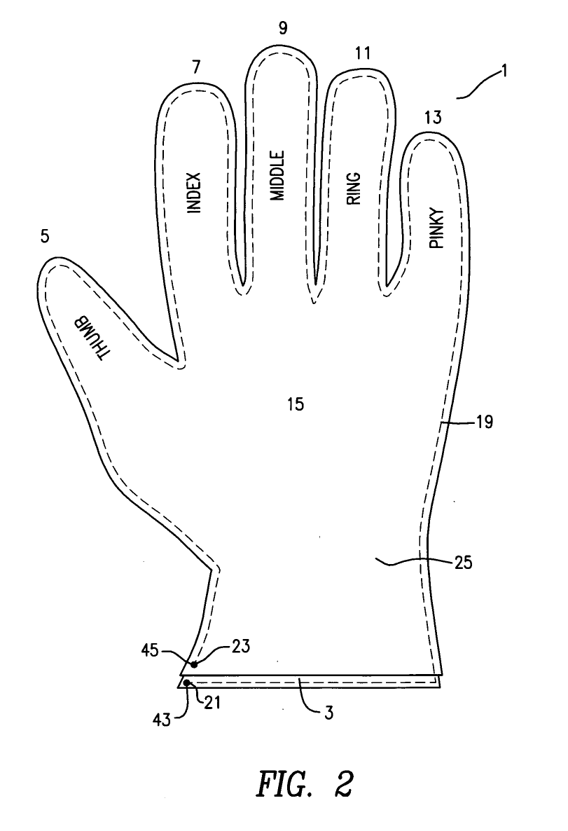

Referring to FIG. 1, a top plan view of the article, and FIG. 2, a bottom plan view of the article, a preferred embodiment of the heated clothing article is illustrated. In the preferred embodiment, the heated clothing apparatus comprises a glove (1) with finger elements (5, 7, 9, 11, 13), an anterior side (25) with a palm (15), a posterior side (17) and an opening (3) for a user's hand. Along the perimeter of the anterior side (25), the posterior side (17) and the finger elements (5, 7, 9, 11, 13) is the heat conducting element (19). In one embodiment, the heat conducting element (19) is a flexible metal wire that is embedded or sewn into the fabric of the glove (1). A first end (21) of the heat conducting element is located on the posterior side (17) of the glove (1) proximal to finger element (5) at the opening (3) of the glove. Conversely, a second end (23) of the heat conducting element (19) is located on the anterior side (25) of the glove (1) proximal to finger element (5) at the opening (3) of the glove. The heat conducting element (19) extends from the first end (21), along the perimeter of the posterior end (17) and the finger elements (5, 7, 9, 11, 13), and terminates at the second end (23) of the glove.

The heat conducting element receives power from a power source (27) in communication with the heat conducting element (19). In FIG. 1, the power source (27) is shown with a positive terminal (29) and a negative terminal (31). In one embodiment, the power source may be a rechargeable 9 volt battery. However, the power source (27) is not limited to a 9 volt rechargeable battery, and it may include any type of light-weight, portable power source. Similarly, the terminals (29) and (31) may be reversed making terminal (29) negative and terminal (31) positive. The terminals (29) and (31) together with the power source (27), communicate with the heat conducting element (19) through electrical contacts (33) and (35) on the heat conducting element (19) located adjacent to the power source's battery terminals (29) and (31). In the preferred embodiment, when the battery terminals (29) and (31) connect with the electrical terminals (33) and (35), respectively, the power source (27) provides heat to the heat conducting element (19).

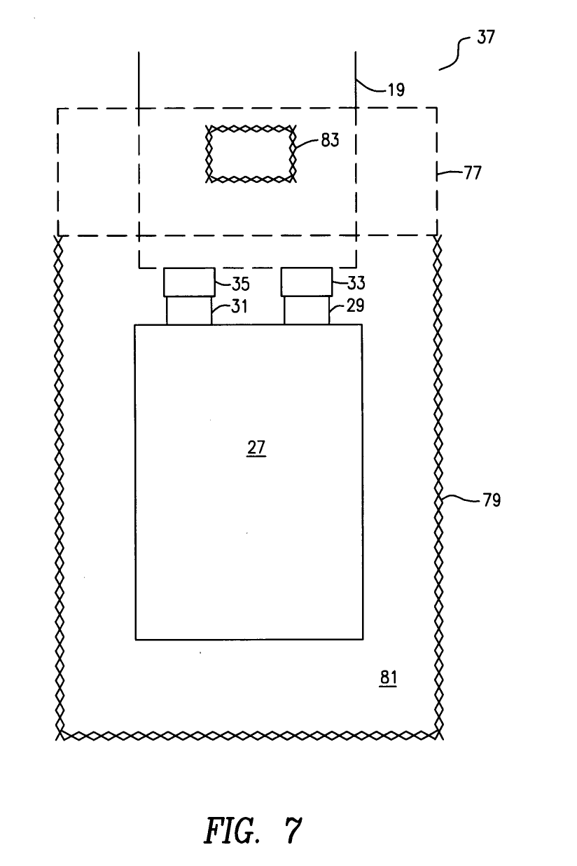

The battery (27) may be enclosed within a enclosure (37) to provide protection to the battery from external elements. FIG. 7 is a top plan view of the battery enclosure (37) is illustrated. In a preferred embodiment, the battery enclosure (37) is formed from a piece of fabric (81) that is stitched (79), or otherwise secured, on three sides to the posterior side (17) of the glove (1). The stitches (79) are positioned on the glove such that they surround the heat conducting element's electrical contacts (33) and (35) on three sides. Furthermore, the fabric (81) is stitched, or otherwise secured, to the glove (1) such that its dimensions may allow a battery to be stored within the battery enclosure (37) and the battery's terminals (29) and (31) may connect to the electrical contacts (33) and (35) of the heat conducting element. The battery (27) is secured within the battery enclosure (37) by a flap (77) and a fastener (83). The flap (77) extends from the fabric (81) above the electrical contacts (33) and (35) and is secured to the glove (1) by the fastener (83). The fastener (83) is shown positioned in the middle portion of the flap (77). The fastener may be in the form of a hook and loop fastener, magnetic elements, mechanically secured elements, etc. A complementary element of the fastening element (83) on the enclosure (37) is positioned on the glove (1) in a vicinity to receive the enclosure fastening element. In operating the battery enclosure (37), the user inserts the battery (27) into the battery enclosure (37) and connects the battery's terminals (29) and (31) to the heat conducting element's electrical terminals (33) and (35), respectively. The user then secures the battery (27) within the enclosure by pressing the flap (77) toward the glove such that the fastener (83) is secured to the glove.

Referring to FIGS. 1 and 2, in another aspect of the preferred embodiment, heat controlling elements (39) and (41) are provided in communication with the heat conducting element (19). In one embodiment, heat controlling element (39) is a resistor that functions to control the flow of heat to the heat conducting element (19). Heat controlling element (39) controls the flow of heat by regulating the voltage of electricity passing from the power source (27) to the heat conducting element (19). The opposing heat control element (41) is a thermostat that also controls the flow of heat to the heat conducting element (19). Accordingly, heat controlling elements (39) and (41) function to ensure that the flow of heat does not exceed a pre-determined threshold.

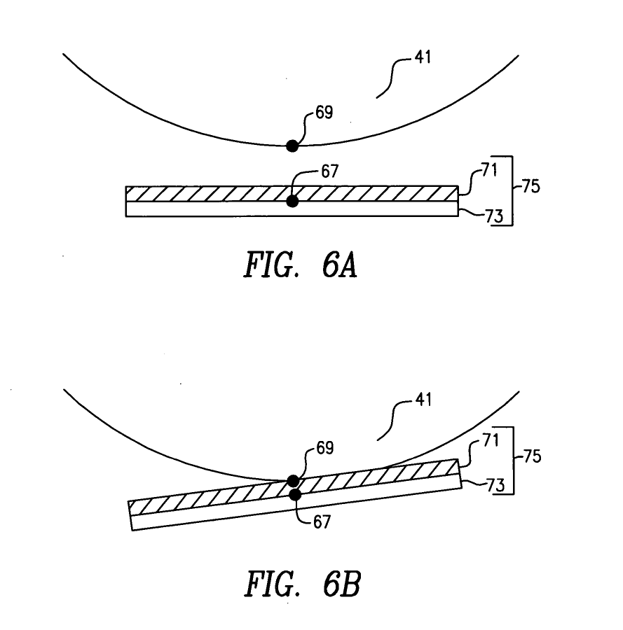

Referring to FIGS. 6A and 6B, the thermostat (41) controls the flow of heat by contact between a first electrode (67) and a second electrode (69). The first electrode (67) is located on a bi-metal rod (75) that is composed of an upper rod (71) and a lower rode (73). The upper rod (71) may be composed of metals with a low specificity of heat. The lower rod (73) may be composed of a different metal with a specificity of heat that is higher than the upper rod (71). The second electrode is located on the heat conducting element (19). Contact between the first electrode (67) and the second electrode (69) is determined by a temperature threshold. When the temperature is above the temperature threshold, the bi-metal rod (75) extends such that the electrodes (67) and (69) are not in contact, as illustrated in FIG. 6A. In this configuration, the thermostat (41) prevents the heat conducting element (19) from receiving power from the power source (27). As the temperature reaches and exceeds the temperature threshold, the lower specificity of heat of the upper rod (71) causes the bi-metal rod to bend such that the two electrodes (67) and (69) are brought into contact, as illustrated in FIG. 6B. Contact between the electrodes (67) and (69) completes the circuit of and activates the heat conducting element (19).

As shown in FIGS. 1 and 2, electrodes (43) and (45) are in communication with the heat conducting element (19). A first electrode (43) is attached to the heat controlling element (19) at a first end (21) and is located within a first housing that is embedded within the fabric of the glove (1). A second electrode (45) is attached to the heat controlling element (19) at a second end (23) and is located with a second housing that is embedded within the fabric of the glove (1). Contact between the first electrode (43) and the second electrode (45) function to secure the glove (1) around a user's hand and to complete the circuit of the heat conducting element.

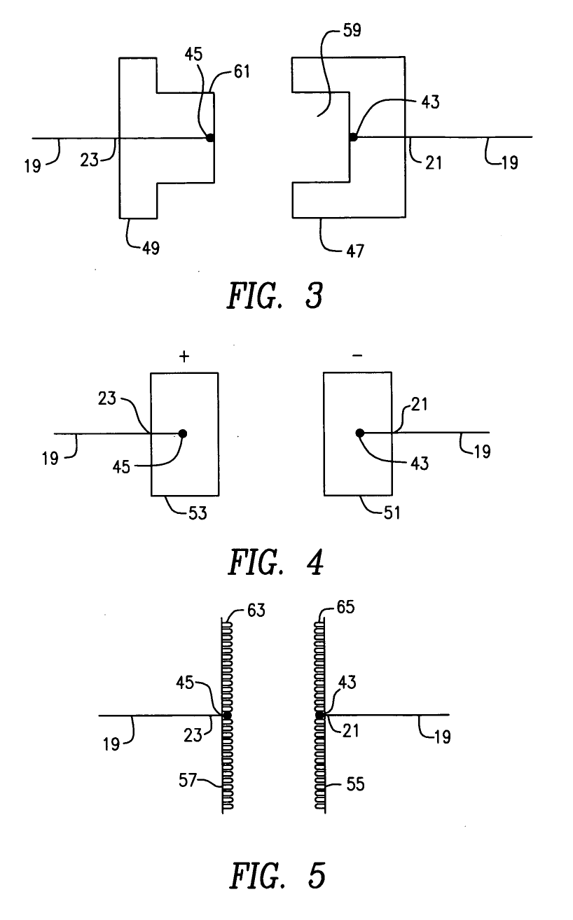

In a preferred embodiment, referring to FIG. 3, first and second electrodes (43) and (45) are contained within housing elements (47) and (49). A first housing element (47) contains the first electrode (43). Conversely, a second housing element (49) contains the second electrode (45). The first housing element (47) includes a recess in the center thereof (59). The second housing element (49) has a protrusion (61) extending from the center thereof. In operation, the user presses the two housing elements together such that the protrusion (61) of the second housing element (49) is inserted into the recess (59) of the first housing element (47) to form a male/female interlocking connection. This connection causes the first electrode (43) to contact the second electrode (45) and completes the circuit of the heat conducting element (19). Moreover, because of the location of the first housing (47) and the second housing (49) on the glove (1), this action secures the opening (3) of the glove to the hand of the user. The first housing (47) and the second housing (49) may be held together by a press fit, a threading connection, or any similar embodiment.

Another embodiment, referring to FIG. 4, is shown with a first and second electrodes (43) and (45) contained within magnetic housing elements (51) and (53), respectively. A first housing element (51) contains the first electrode (43). Conversely, a second housing element (53) contains the second electrode (45). In the embodiment illustrated in FIG. 4, the first housing element (51) has a negative magnetic polarity. The second housing element (53) has a positive magnetic polarity. In operation, the user presses the two housing elements together such that the opposing magnetic polarities pull the two housing elements together. This action causes the first electrode (43) to contact the second electrode (45) and it completes the circuit of the heat conducting element (19). Moreover, because of the location of the first housing (51) and the second housing (53) on the glove (1), this action secures the opening (3) of the glove to the hand of the user.

Referring to FIG. 5, another embodiment is shown with first and second electrodes (43) and (45) contained within housing elements (55) and (57), respectively. A first housing element (55) contains the first electrode (43). Conversely, a second housing element (57) contains the second electrode (45). The first housing element (55) has a plurality of hooks (65) on the surface thereof. The second housing element (57) has a plurality of loops (63) extending from the surface thereof. In operation, the user presses the two housing elements together such that the hooks (65) of the first housing element (55) fasten to the loops (63) of the second housing element (57). Because of the location of the first housing (55) and the second housing (57) on the glove (1), this action causes the first electrode (43) to contact the second electrode (45) and it completes the circuit of the heat conducting element (19). Moreover, this action secures the opening (3) of the glove to the hand of the user.

### Advantages Over the Prior Art

The present invention discloses a heated clothing apparatus, such as a glove, that can be heated with a heating element, a power source, and a thermometer. This invention is advantageous over the prior art because, the ends of the heating elements are conductors and are embedded within the fabric of opposing sides of the wrist of the glove. When the ends of the heat conducting elements are connected together the circuit between the heating element, power source and thermometer is closed. Furthermore, connected the ends of the heat conducting elements functions to secure the glove and all of its above elements to the user's hand.

### ALTERNATIVE EMBODIMENTS

It will be appreciated that, although specific embodiments of the invention have been described herein for purposes of illustration, various modifications may be made without departing from the spirit and scope of the invention. In particular, the mechanism for securing the electrodes to close the circuit may include alternative mechanisms including mechanical, electrical, and electro-mechanical technologies. Furthermore, the invention should not be limited to a glove article. Rather, the invention may be applied to various other articles of material, such as mittens, hats, socks, shirts, coats, pants, blankets, etc. In one embodiment, the thermostat and resistor may be replaced with a thermistor. Accordingly, the scope of protection of this invention is limited only by the following claims and their equivalents.

I claim:

1. An article of clothing, such as a glove, comprising:
a fabric enclosure with an opening adapted to receive a user's body part extremity within;
said fabric enclosure having a first end and a second end adapted to secure said user's extremity within said fabric enclosure;
a heat conducting element embedded along a perimeter of said fabric enclosure, wherein said heat conducting element is adapted to deliver heat to said body part extremity when secured within said fabric enclosure;
a heat control element in communication with said heat conducting element, wherein said heat control element is adapted to adjust the flow of heat within said heat conducting element;
a power source in mechanical communication with said heat conducting element and said heat control element; and
a first electrode connected to a first end of said heat conducting element, a second electrode connected to a second end of said heat conducting element, wherein a first fastening element in communication with said first electrode and a second fastening element in communication with said second electrode closes the circuit and secures said first and second ends of said fabric enclosure around said user's extremity.

2. The article of claim 1, wherein said user's extremity is a hand and said fabric enclosure is selected from a group consisting of: a glove and a mitten.

3. The article of claim 1, wherein said heat conducting element is selected from a group consisting of: metal and wire.

4. The article of claim 1, wherein said heat control element is a resistor that is located on a posterior side of said fabric enclosure proximal to said power source.

5. The article of claim 4, wherein said heat control element includes a bimetal thermostat located on said posterior side of said fabric enclosure proximal to said power source such that said thermostat and said resistor are on opposing sides of said power source.

6. The article of claim 1, wherein said heat conducting element is embedded within said fabric enclosure such that said heat conducting element begins at said first electrode, extends along the perimeter of the palm and finger elements of a glove or mitten, and terminates at said second electrode.

7. The article of claim 6, wherein said first electrode is located on the posterior side of the wrist of a glove or mitten and the second electrode is located on the anterior side of the wrist of the glove or mitten wherein the user can connect said first electrode to said second electrode.

8. The article of claim 7, wherein said first electrode is embedded within a first housing and said second electrode is embedded within a second housing such that said first housing and said second housing are adapted to mechanically secure.

9. The article of claim 7, wherein said first electrode is embedded within a first housing and said second electrode is embedded within a second housing such that said first housing and said second housing are comprised of a magnetic material of opposite polarity and said first and second housings are adapted to magnetically secure.

10. The article of claim 7, wherein said first electrode is embedded within a first housing and said second electrode is embedded within a second housing such that said first housing and said second housing are comprised of hook and loop fasteners and are adapted to mechanically secure.
